(19) United States
(12) Patent Application Publication
(10) Pub. No.: US 2025/0098585 A1
(43) Pub. Date: Mar. 27, 2025

(54) LANDSCAPE RAKE

(71) Applicant: Xue-feng Chen, Guangzhou City (CN)

(72) Inventor: Xue-feng Chen, Guangzhou City (CN)

(21) Appl. No.: 18/371,448

(22) Filed: Sep. 22, 2023

(51) Int. Cl. A01D 42/06; B25G 1/04; B25G 3/38

(52) U.S. Cl. CPC A01D 42/06; B25G 1/04; B25G 3/38

(57) ABSTRACT

A landscape rake of the present invention includes a rake handle component, a rake body component and at least two linkage rod assemblies. The rake handle component is assembled by a plurality of rods, and one of the rods has a first fixed portion and a second fixed portion. The rake body component has rake heads formed with a plurality of tines and pivotally assembled with the first fixed portion and the at least two linkage rod assemblies, respectively. Each of the at least two linkage rods has one end pivotally assembled with the second fixed portion. Accordingly, the rake heads can be unfolded or folded relative to the rake body component, thereby saving storage space and improving portability.

### BACKGROUND OF THE INVENTION

### Fields of the invention

The present invention relates to a weed removal tool and, more particularly, to a landscape rake suitable for ponds, gardens, or beaches.

### Descriptions of Related Art

In garden ponds and aquatic plant nurseries, water quality often does not meet the required standards, leading to excessive growth or rapid growth of weeds and secondary water pollution from nutrients decomposed and released by aquatic plants. Therefore, it is essential to clear weeds in garden ponds. However, currently available pond rakes have a single structure and typically cannot be adjusted in handle length. Therefore, they are not suitable for users of different body types and lack practicality. Furthermore, the existing pond rakes have a fixed configuration between the handle and the rake head without a folding function and thus are too wide for use in small ponds. Additionally, in the absence of folding function, their bulky volume leads to inefficient use of space and makes storage and transportation inconvenient. Therefore, the current pond rakes do not meet consumer needs.

### SUMMARY OF THE INVENTION

The primary objective of the present invention is to provide a landscape rake with a length-adjustable handle and a foldable/unfoldable rake head.

To achieve the above-mentioned objective, the present invention provides a landscape rake of the present invention, which comprises a rake handle component assembled by a plurality of rods. One of the rods of the rake handle component has a first fixed portion and a second fixed portion. The first fixed portion has a first socket pipe and first hinge assemblies connected to both sides of the first socket pipe. Each of the first hinge assemblies has a first limiting groove in communication with an interior of the first socket pipe. The second fixed portion has second socket pipe and second hinge assemblies connected to both sides of the second socket pipe. Each of the second hinge assemblies has a second limiting groove in communication with an interior of the second socket pipe. The landscape rake further comprises a rake body component having at least two rake heads. Each of the rake heads has one side facing toward the rake handle component and provided with a transverse plate protruding therefrom and is equipped with a plurality of tines. The transverse plate of each of the rake heads is pivoted at the first limiting groove of the respective first hinge assembly, such that the first limiting groove provides a limiting effect for pivot motion of the transverse plate within the first limiting groove. The landscape rake further comprises at least two linkage rod assemblies, each having a first connecting rod and a second connecting rod pivotally connected with each other. Each of the first connecting rods is pivoted at the second limiting groove of the respective second hinge assembly such that the second limiting groove provides a limiting effect for pivot motion of the respective first connecting rod within the second limiting groove. Each of the second connecting rod is pivoted at the transverse plate of the respective rake head.

In the present invention, each of the rods has a corresponding positioning hole such that the rods can be assembled or disassembled from each other by using a positioning element to lock or unlock the positioning hole.

In the present invention, the first socket pipe of the first fixed portion is fastened to the end of the rod by inserting a pin into the rod.

In the present invention, the second socket pipe of the second fixed portion is fastened to the rod at an appropriate distance from the first fixed portion by inserting a pin into the rod.

In the present invention, each of the tines has one end formed with a hook portion at a lateral surface thereof facing towards the rake handle component.

In the present invention, each of the tines is equipped with a reinforced portion protruding from a middle portion thereof to enhance the overall rigidity and strength of the tines.

In the present invention, a pivotal connection mechanism between the first connecting rod and the second connecting rod is configured by a pivot element.

In the present invention, the two rake heads are independently pivoted to a respective one of the first hinge assemblies and a respective one of the second connecting rods, allowing individually or simultaneously folding or unfolding of the two rake heads.

In the present invention, there are pivot-based assembly and disassembly structures between the two rake heads and the first hinge assemblies and between the two rake heads and the second connecting rods.

In the present invention, when the two rake heads swing in a direction towards the rake body component, the first connecting rods and the second connecting rods pivot through the first limiting grooves and the second limiting grooves, respectively, causing the two rake heads to be operated into a folding state.

In the present invention, when the two rake heads swing in a direction away from the rake body component, the first connecting rods and the second connecting rods pivot through the first limiting grooves and the second limiting grooves, respectively, causing the two rake heads to be operated into an unfolding state.

### BRIEF DESCRIPTION OF THE DRAWINGS

FIG. 1 is a partially exploded perspective view of the present invention.

FIG. 2 is an assembled perspective view of the present invention.

FIG. 3 is an exploded and enlarged view of the linkage rod assembly and fixing elements of the present invention.

FIG. 4 is an assembled and enlarged view of the linkage rod assembly and fixing elements of the present invention.

FIG. 5 is a cross-sectional view of the first fixed portion and the second fixed portion fixed on the rod of the present invention.

FIG. 6 is a perspective view of another embodiment of the present invention.

FIG. 7 is a partially enlarged view of the first fixed portion of the present invention.

FIG. 8 is a partially enlarged view of the second fixed portion of the present invention.

FIG. 9 is a partially enlarged view of the rake head of the present invention.

FIG. 10 is a schematic view of the use state of the present invention for weed removal.

FIG. 11 is a schematic view of both rake heads of the present invention being folded simultaneously.

FIG. 12 is a schematic view of a single rake head of the present invention being folded.

FIG. 13 is a schematic view of the rake heads of the present invention being fully folded.

FIG. 14 is a schematic view of the rake heads of the present invention being fully unfolded.

FIG. 15 is a schematic view from another angle of the rake heads of the present invention being fully unfolded.

### DETAILED DESCRIPTION OF THE PREFERRED EMBODIMENT

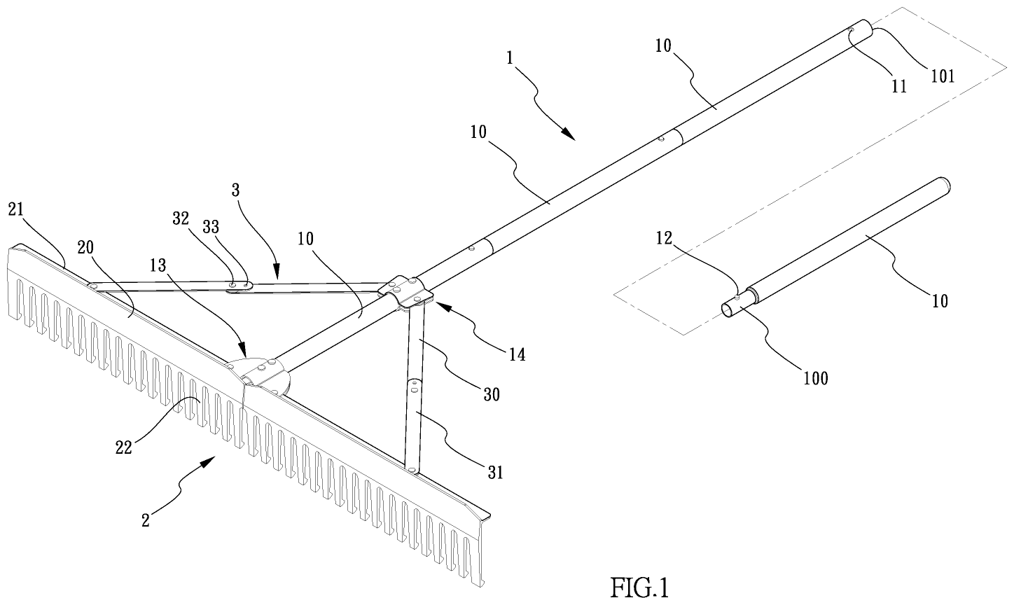

As shown in FIGS. 1 to 15, the present invention provides a landscape rake, comprising: a rake handle component 1, a rake body component 2 and at least two linkage rod assemblies 3.

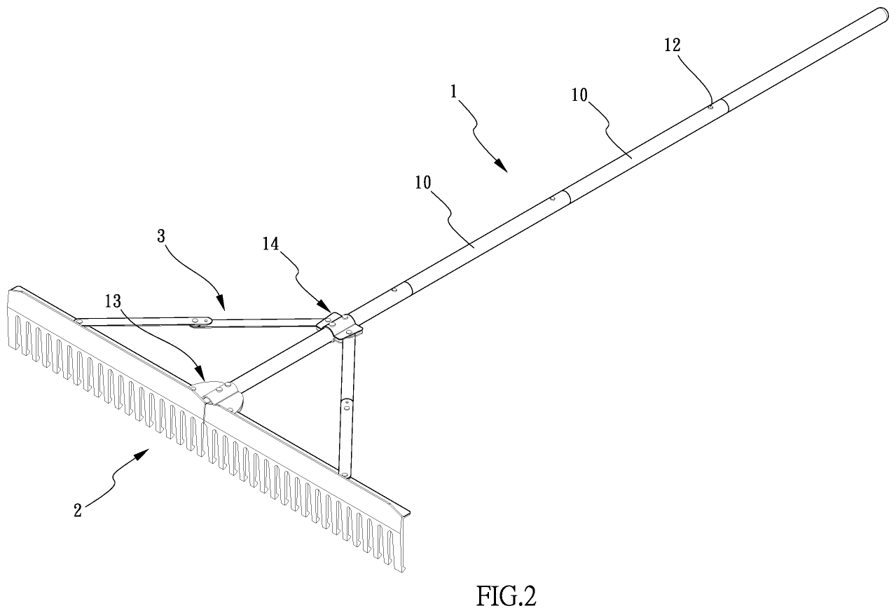

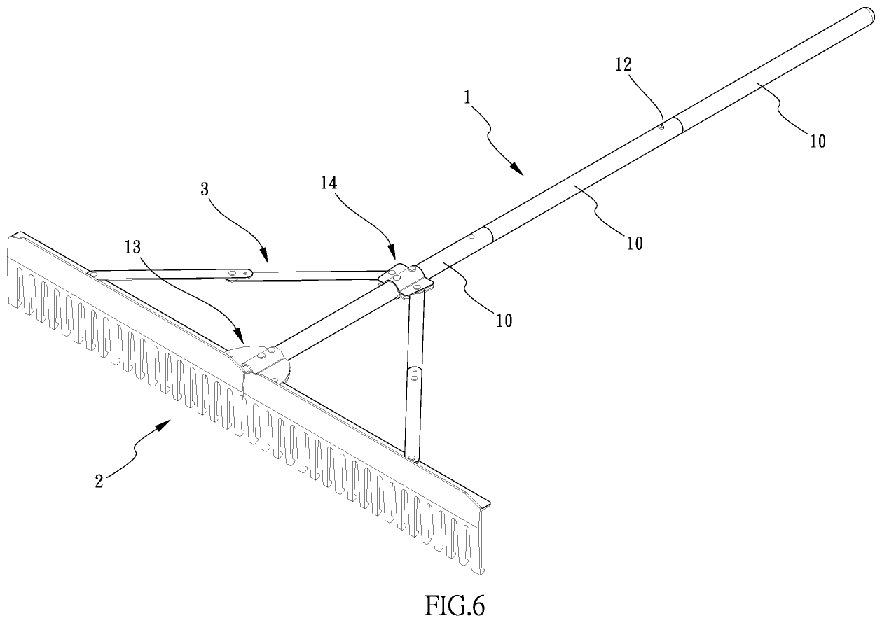

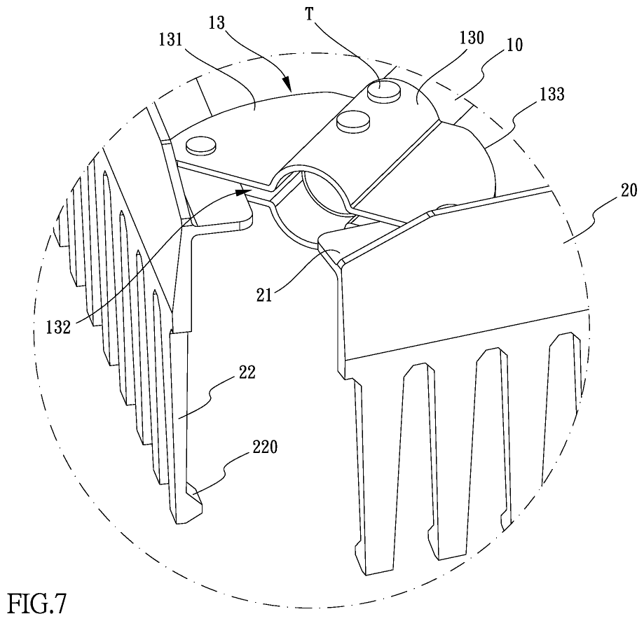

The rake handle component 1 is assembled from a plurality of rods 10 each having a corresponding positioning hole 11. The assembly and disassembly of the rods 10 can be achieved by elastically positioning or detaching positioning elements 12 from their respective positioning holes 11 or by other various manners. For example, one end of the rod 10 has a protrusion 100 configured with a positioning element 12 thereon, and the other end of the rod 10 has a groove 101 configured with a positioning hole 11. The protrusion 100 of one rod 10 can be assembled into the groove 101 at the opposite end of another rod 10 to allow the positioning element 12 to be positioned in the positioning hole 11, achieving the assembly and disassembly structure between the rods 10. In this embodiment, there are four rods 10 (as shown in FIG. 2) or three rods 10 (as shown in FIG. 6) in the assembly.

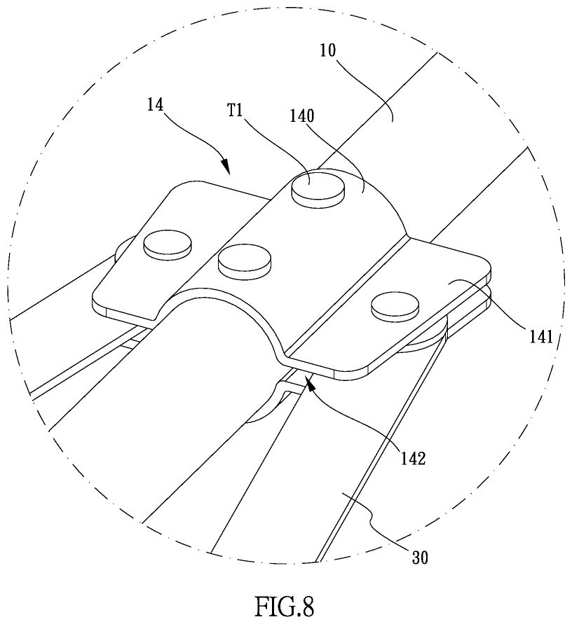

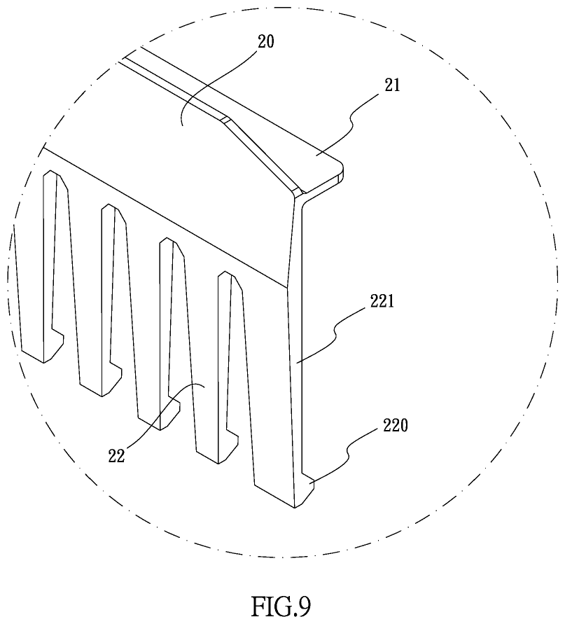

For further illustration, the rod 10 has a first fixed portion 13 and a second fixed portion 14. The first fixed portion 13 has a first socket pipe 130 and first hinge assemblies 131 connected to both sides of the first socket pipe 130. The first fixed portion 13 is fixed to the end of the rod 10 by inserting a pin T into the first socket pipe 130 and the rod 10, as shown in FIGS. 5 and 7. Each of the first hinge assemblies 131 is configured by binding two pieces to form a first limiting groove 132 between the two pieces, which is in communication with the interior of the first socket pipe 130. Each of the first hinge assemblies 131 has an outer edge shaped into an arc 133 to prevent the user from being cut during operation. Furthermore, the second fixed portion 14 includes a second socket pipe 140 and second hinge assemblies 141 connected to both sides of the second socket pipe 140. The second fixed portion 14 is fixed to the rod 10 by inserting a pin Tl into the second socket pipe 140 and the rod 10, as shown in FIGS. 5 and 8. The second fixed portion 14 is maintained at an appropriate distance from the first fixed portion 13, and each of the second hinge assemblies 141 is configured by binding two pieces to form a second limiting groove 142 between the two pieces, which is in communication with the interior of the second socket pipe 140.

The rake body component 2 has at least two rake heads 20. Each of the rake heads 20 is provided with a transverse plate 21 protruding from its side facing toward the rod 10 and a plurality of tines 22 protruding from its bottom. The transverse plate 21 of each rake head 20 is pivoted at the first limiting groove 132 of the respective first hinge assembly 131. As such, the first limiting groove 132 provides a limiting effect for pivot motion of the transverse plate 21 of the respective rake head 20 within the first limiting groove 132, ensuring the smoothness of the pivot motion for the rake head 20. Each of the tines 22 has one end formed with a hook portion 220 at its lateral surface facing towards the rod 10. The hook portions 220 can be adjusted to various angles to adapt to different types of terrain where weeds may be present, thereby enhancing the smoothness and reliability of the tines 22 when raking weeds. Moreover, each of the tines 22 is equipped with a reinforced portion 221 protruding from its middle portion, characterized by a notable thickness, as shown in FIG. 9. The reinforced portion 221 enhances the overall rigidity and strength of each tine 22, preventing damage of the tines 22 during use.

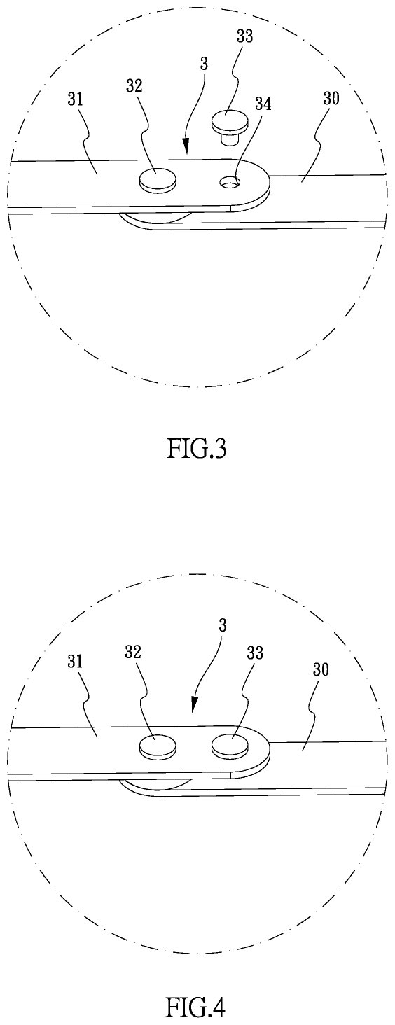

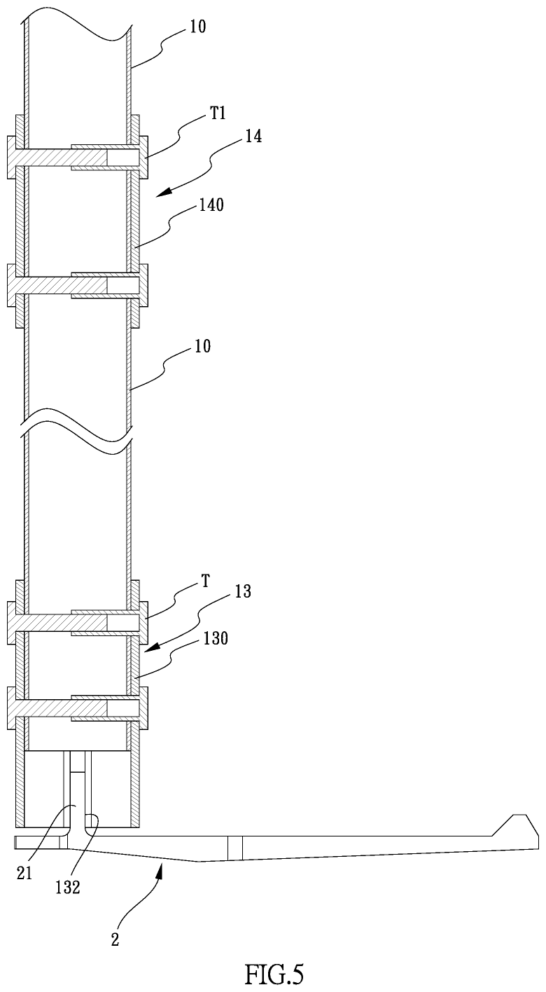

The at least two linkage rod assemblies 3 individually have a first connecting rod 30 and a second connecting rod 31. The pivotal connection mechanism between the first connecting rod 30 and the second connecting rod 31 is achieved by a pivot element 32. Each of the first connecting rods 30 is pivoted at the second limiting groove 142 of the respective second hinge assembly 141, as shown in FIG. 7. By the second limiting groove 142, the pivot motion of the first connecting rod 30 within the second limiting groove 142 maintains stability. Each of the second connecting rods 31 is pivoted at the transverse plate 22 of the respective rake head 20 to allow pivot motion of the second connecting rod 31 relative to the transverse plate 22 of the rake head 20. Additionally, when the two rake heads 20 of the rake body component 2 are unfolded, a fixing element 33 is fastened to a fixing hole 34 between the first connecting rod 30 and the second connecting rod 31, as shown in FIGS. 3 and 4. This creates a fixed joint structure between the first connecting rod 30 and the second connecting rod 31, preventing the folding of the two rake heads 20 during use.

In terms of usage, users can grip the rake handle component 1 and detach the positioning elements 12 from the positioning holes 11 of the rods 10 and then assemble the appropriate number of the rods 10 according to their individual conditions such as height and arm length. As such, the length of the rake handle component 1 can be adjusted to match their own conditions. This adjustment allows the user to effectively remove weeds from the pond using the tines 22 of the rake heads 20.

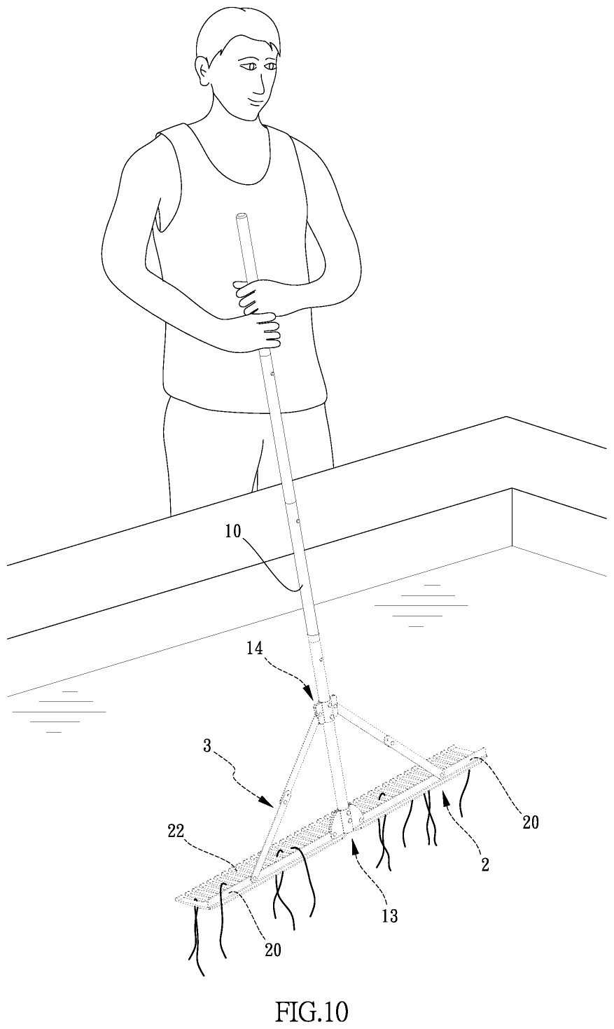

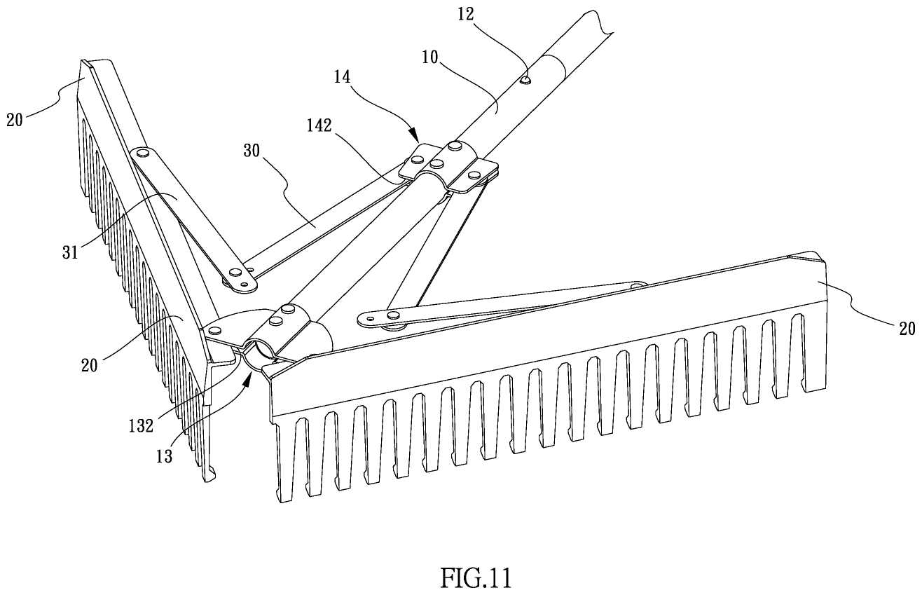

It is worthy to note that if, during use, one accidentally drops the rod 10 into the pond, the transverse plates 21 of the rake heads 20 can provide buoyancy, allowing the rod 10 to float on the water's surface. This enables the user to retrieve the rod 10 without it sinking to the bottom of the pond. Furthermore, in the present invention, the two rake heads 20 of the rake body component 2 are independently pivoted at a respective one of the first hinge assemblies 131 and a respective one of the second connecting rods 31. As a result, users can choose the configuration of the rake heads 20 based on the specific conditions at the site. For example, when dealing with a smaller pond area, one rake head 20 can be deployed while the other is folded, whereas for a larger pond area, both rake heads 20 can be deployed simultaneously, as shown in FIG. 10. Additionally, the wide spacing among the tines 22 can maintain the flatness of the pond bottom during weed removal, preventing the issue of flatness that might occur with excessive narrow spacing among the tines 22.

Furthermore, when clearing weeds with different root structures, conventional rake heads 20 cannot be detached, which means users have to rely on their own experience to adjust the angle at which the rake head 20 contacts the weeds in order to achieve the desired removal effect. However, in the present invention, the two rake heads 20 are designed to be attachable to and detachable from the first hinge assemblies 131 and the second connecting rods 31, respectively. This allows users to choose different types of rake heads 20 and addresses the limitation caused by irreplaceability of the rake heads 20.

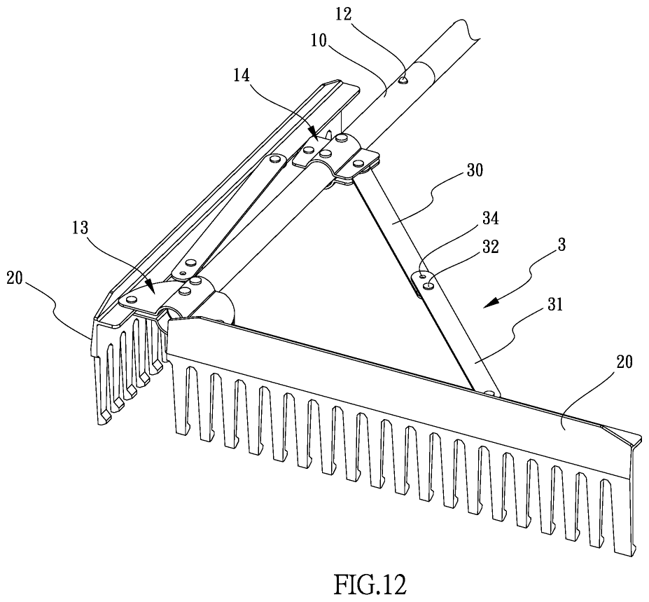

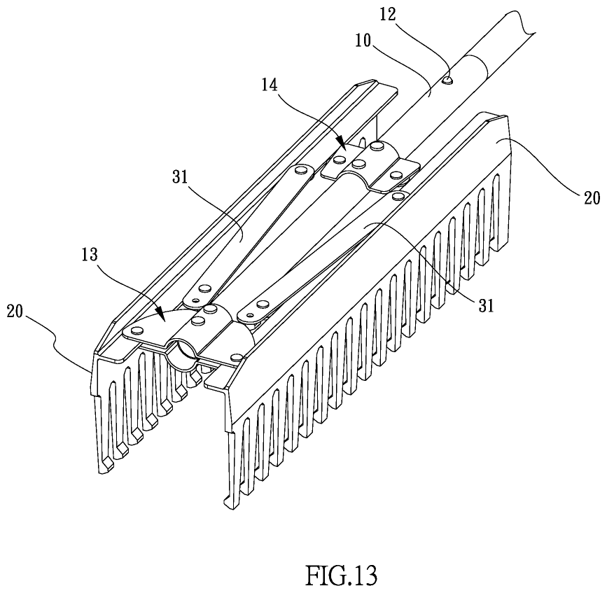

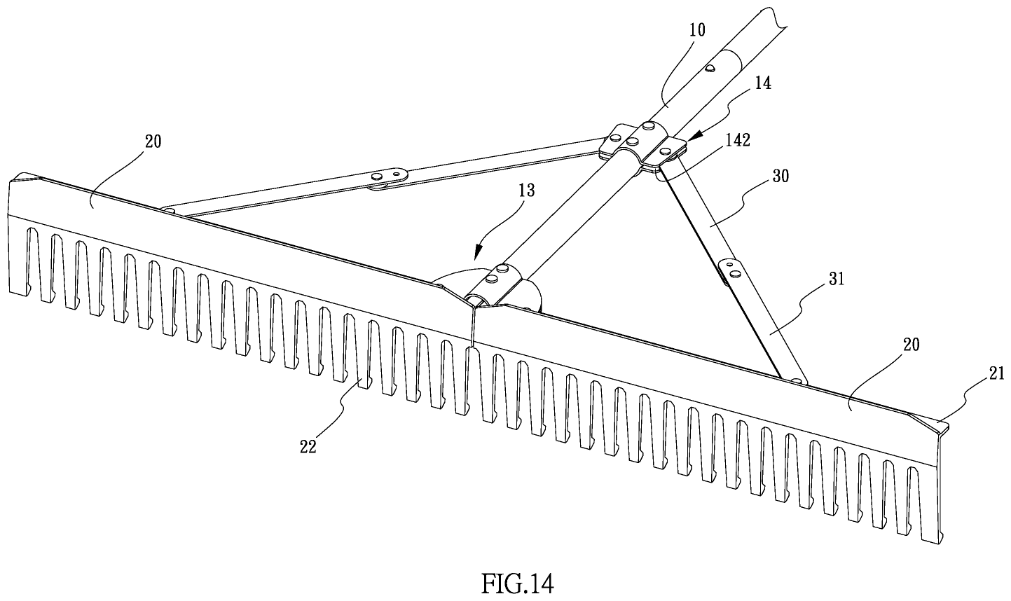

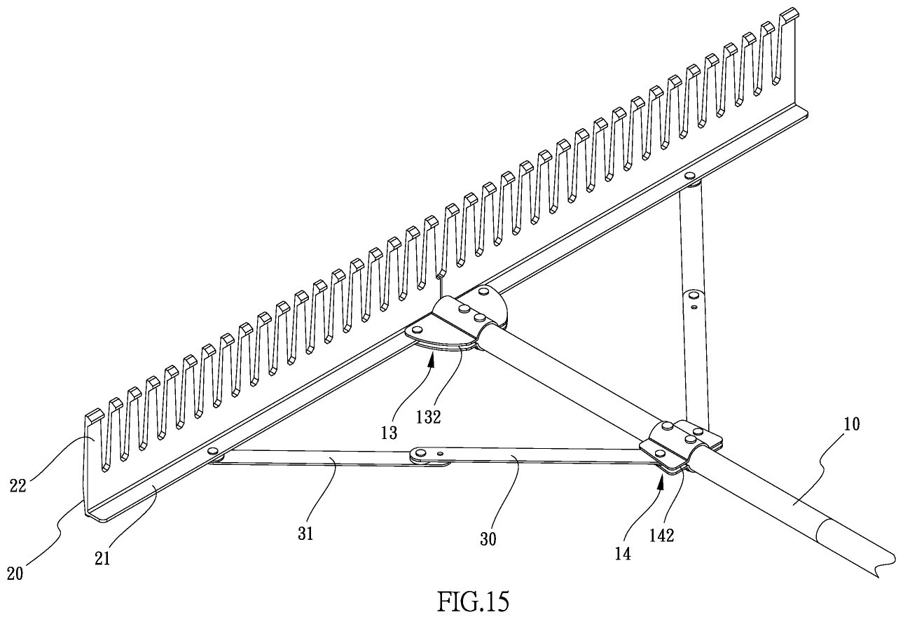

Another technical feature of the present invention is that the two rake heads 20 of the rake body component 2 are collapsible relative to the rod 10. For example, when folding the two rake heads 20, the operation involves swinging the two rake heads 20 towards the rake handle component 1 and pivoting the first connecting rods 30 and the second connecting rods 31 through the second limiting grooves 142 and the first limiting grooves 132, respectively, to bend the first connecting rods 30 and the second connecting rods 31, as shown in FIG. 11. Alternatively, the first connecting rod 30 and the second connecting rod 31 of one linkage rod assembly 3 can be bent while the other assembly remains straight, resulting in folding of a single rake head 20, as shown in FIG. 12. When the two rake heads 20 are completely folded, the first connecting rods 30 abut against the rake body component 1, as shown in FIG. 13. On the contrary, for unfolding both rake heads 20 simultaneously, the operation involves swinging the two rake heads 20 away from the rake body component 1 and pivoting the first connecting rods 30 and the second connecting rods 31 through the second limiting grooves 142 and the first limiting grooves 132, respectively, until the first connecting rods 30 and the second connecting rods 31 are fully extended, as shown in FIGS. 14 and 15. Accordingly, when not in use, the present invention allows for the folding of the two rake heads 20, saving storage space and improving portability. Additionally, since the rake heads 20 and the rake body component 1 are connected by the two-stage configured linkage rod assemblies 3, the speed of unfolding and folding the rake heads 20 can be increased.

The above-described embodiments are only exemplary implementations of the present invention. The scope of the present invention is not limited to these embodiments. Any person skilled in the art, within the technical scope disclosed by the present invention, can make equivalent substitutions or modifications based on the technical concept and ideas of the present invention, all of which should be considered within the scope of the present invention.

What is claimed is:

1. A landscape rake, comprising:
a rake handle component, assembled by a plurality of rods, wherein (i) one of the rods at an end portion of the rake handle component has a first fixed portion and a second fixed portion, (ii) the first fixed portion has a first socket pipe and first hinge assemblies connected to both sides of the first socket pipe, (iii) each of the first hinge assemblies has a first limiting groove in communication with an interior of the first socket pipe, (iv) the second fixed portion has second socket pipe and second hinge assemblies connected to both sides of the second socket pipe, and (v) each of the second hinge assemblies has a second limiting groove in communication with an interior of the second socket pipe;
a rake body component, having at least two rake heads, wherein (i) each of the rake heads has one side facing toward the rake handle component and provided with a transverse plate protruding therefrom and is equipped with a plurality of tines, (ii) the transverse plate of each of the rake heads is pivoted at the first limiting groove of the respective first hinge assembly, and (iii) the first limiting groove provides a limiting effect for pivot motion of the transverse plate of the respective rake head within the first limiting groove; and
at least two linkage rod assemblies, each having a first connecting rod and a second connecting rod pivotally connected with each other, wherein (i) each of the first connecting rods is pivoted at the second limiting groove of the respective second hinge assembly, (ii) the second limiting groove provides a limiting effect for pivot motion of the respective first connecting rod within the second limiting groove, and (iii) each of the second connecting rods is pivoted at the transverse plate of the respective rake head.

2. The landscape rake as claimed in claim 1, wherein each of the rods has a corresponding positioning hole which allows a positioning element to be positioned therein or detached therefrom, enabling assembly or disassembly configuration of the rods.

3. The landscape rake as claimed in claim 1, wherein the first socket pipe of the first fixed portion is fastened to one end of the rod by inserting a pin into the rod.

4. The landscape rake as claimed in claim 1, wherein the second socket pipe of the second fixed portion is fastened to the rod at an appropriate distance from the first fixed portion by inserting a pin into the rod.

5. The landscape rake as claimed in claim 1, wherein each of the tines has one end formed with a hook portion at a lateral surface thereof facing towards the rake handle component.

6. The landscape rake as claimed in claim 1, wherein each of the tines is equipped with a reinforced portion protruding from a middle portion thereof to enhance strength of the tines.

7. The landscape rake as claimed in claim 1, wherein a pivotal connection mechanism between the first connecting rod and the second connecting rod is configured by a pivot element.

8. The landscape rake as claimed in claim 1, wherein a fixing element is fastened to a fixing hole between each of the first connecting rods and each of the second connecting rods, preventing folding of the two rake heads during use.

9. The landscape rake as claimed in claim 1, wherein the two rake heads are independently pivoted to a respective one of the first hinge assemblies and a respective one of the second connecting rods, allowing individually or simultaneously folding or unfolding of the two rake heads.

10. The landscape rake as claimed in claim 1, wherein the two rake heads are pivotally connected with a respective one of the first hinge assemblies and a respective one of the second connecting rods.

11. The landscape rake as claimed in claim 1, wherein the two rake heads are operated into a folding state when swinging in a direction towards the rake handle component along with pivot motion of the first connecting rods and the second connecting rods through the first limiting grooves and the second limiting grooves, respectively.

12. The landscape rake as claimed in claim 1, wherein the two rake heads are operated into an unfolding state when swinging in a direction away from the rake handle component along with pivot motion of the first connecting rods and the second connecting rods through the first limiting grooves and the second limiting grooves, respectively.

13. The landscape rake as claimed in claim 1, wherein the tines of the two rake heads are arranged in a uniform spacing configuration.

14. The landscape rake as claimed in claim 1, wherein the tines of the two rake heads are arranged in a non-uniform spacing configuration.

15. The landscape rake as claimed in claim 1, wherein the tines of the two rake heads are arranged in a wide spacing configuration.

16. The landscape rake as claimed in claim 11, wherein the tines of the two rake heads are arranged in a narrow spacing configuration.
